(19) United States
(12) Patent Application Publication
(10) Pub. No.: US 2008/0055378 A1
(43) Pub. Date: Mar. 6, 2008

(54) Fluid Supply Method and Apparatus

(76) Inventors: Paul R. Drury, Hertfordshire (GB); Stephen Temple, Cambridge (GB); Michael Purser, Cambridge (GB)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/575,383

(22) PCT Filed: Sep. 19, 2005
(86) PCT No.: PCT/GB05/03588

§ 371 Date: May 2, 2007

(30) Foreign Application Priority Data
Sep. 18, 2004 (GB) 0420795.7
Apr. 7, 2005 (GB) 0507038.8
Apr. 27, 2005 (GB) 0508516.2

(51) Int. Cl. B41J 2/19; B41J 2/20

(52) U.S. Cl. 347/92

(57) ABSTRACT

A method and apparatus for supplying fluid to a deposition device or printhead using the through flow principle. The pressure of fluid entering and exiting the printhead is controlled directly at the printhead by respective pressure controllers, preferably a transducer and control system or a weir. The pressure controllers can be integrated together and mounted on or further integrated with the printhead. The supply system preferably forms a closed loop including a remote reservoir, and the entire system can be arranged such that the overall free surface of fluid is exposed on average to a negative gauge pressure.

The present invention relates to fluid supply systems for droplet deposition apparatus and particularly ink supply systems for drop-on-demand inkjet print heads operating on the through-flow principle.

In known through-flow arrangements, ink is removed from a print head so as to remove dirt and air bubbles that might block the print head nozzles and heat from the ink ejecting mechanisms that might change the viscosity of the ink and so affect print quality. The head is replenished with filtered ink at an appropriate temperature. Ink removal and replenishment typically take place continuously, with removed ink being filtered and cooled before being fed back to the print head. Through-flow may be restricted to the print head manifold or may pass through each print head ejecting chamber where it can remove any dirt or air bubbles that may have lodged in the respective ink ejecting nozzle.

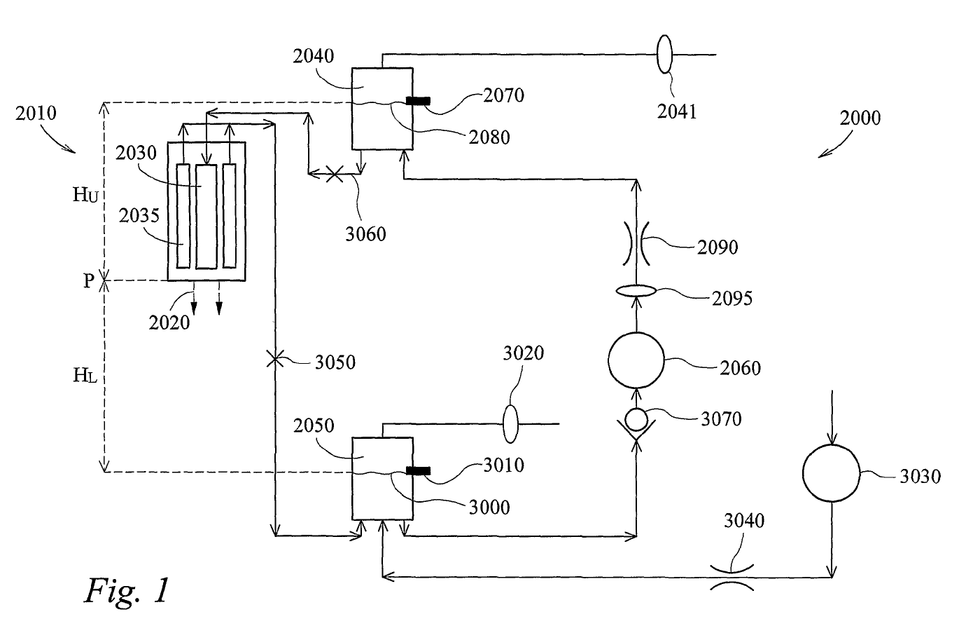

Such an arrangement is known from WO00/38928, belonging to the present applicant and incorporated herein by reference, and is reproduced in FIG. 1. A through flow print head 2010 of the kind known e.g. from WO91/17051, belonging to the present applicant and incorporated herein by reference, is arranged with its channel array lying horizontal and its nozzles directed for downward ejection as indicated at 2020 (although non-horizontal arrangements are equally possible). As is known in the art, channels are defined by at least one wall that can be displaced transversely to the longitudinal axis of the channel, thereby to generate pressure waves in the fluid in the channel which in turn effect droplet ejection from the nozzle. The walls are displaced by piezoelectric actuators, advantageously located in the walls themselves and operating in shear mode as is also known in the art.

An upper reservoir 2040 open to the atmosphere via air filter 2041 feeds the central inlet manifold 2030 via a flexible conduit 3060. The upper reservoir is in turn supplied with ink from a lower reservoir 2050 by means of a pump 2060. Pump 2060 is controlled by a sensor 2070 in the upper reservoir in such a manner as to maintain the fluid level 2080 therein at a constant height H_{U} above the plane P of the nozzles. In the lower reservoir 2050, the fluid level 3000 is maintained at a constant height H_{L} below the nozzle plane P by a sensor 3010 which controls a pump 3030 connected to an ink storage tank (not shown). Filter 3020 serves the same purpose as in the upper reservoir. Lower reservoir 2050 is connected to the outlet manifolds 2035 of the print head by conduit 3050.

The positive pressure applied by the upper reservoir to the print head inlet manifold together with the negative pressure applied by the lower reservoir to the print head outlet manifold generates flow through the fluid chambers of the array as described above. In a through flow printhead the channel represents a relatively high impedance to the fluid flow, typically an order of magnitude higher than the impedance of the manifold. Therefore, to maintain a desired flow rate through the channels, a relatively large pressure difference must be maintained between the inlet and outlet manifolds. An ink flow rate through the channel equal to ten times the maximum rate of ink ejection from the channel nozzle is mentioned in WOOO/38928, a figure that also applies to the present invention. In addition, a slightly negative, sub-atmospheric pressure is established at the nozzle of each print head ejecting chamber, thereby ensuring that the ink meniscus in the nozzle does not break, even when subject to mild positive pressure pulses of the kind typically generated during operation of print heads as a result of the movement of ink supply tubes, vibration from the paper feed mechanism, etc. It will be appreciated that the above arrangement requires careful control of the relative vertical spacing H_{U}, H_{L} of the ink supply reservoirs and print head. Moreover, it has been found necessary to use large bore ink pipes between the reservoirs and the print head to ensure that changes in ink flow to and from the print head resulting from changes in the print pattern (and thus the amount of ink actually ejected from the print head) do not unduly affect the pressures at the print head. However, these requirements also restrict the manner in which such a print head can be installed. In particular, scanning installations in which a print head is mounted on a carriage which moves across a substrate are difficult to implement, requiring inter alia a carriage mechanism that can move both the printhead and the ink pipes.

According to a first aspect of the invention there is provided a fluid supply apparatus for supplying fluid to a droplet deposition device, the droplet deposition device having an inlet, an outlet and including at least one pressure chamber in communication with an ejection nozzle, said apparatus comprising a fluid reservoir for supplying fluid to and receiving fluid from the droplet deposition apparatus; an inlet pressure controller adapted to receive fluid from said reservoir and maintain the pressure of fluid at said inlet at a first predetermined value; an outlet pressure controller adapted to return fluid to said reservoir and maintain the pressure of fluid at said outlet at a second predetermined value; the difference between said first and second values driving a flow of fluid through said at least one pressure chamber.

By controlling the pressure directly at the inlet and outlet of the droplet deposition device, the pressure at the nozzle is accurately maintained, independent of any fluctuations or disturbances in the fluid supply to up to and from the device (preferably a multi nozzle printhead unit). The inlet and outlet pressures can be controlled independently. The impedance between the inlet and the nozzles and the nozzles and the outlet are known to a high degree of accuracy due to precise manufacturing of the printhead, and is substantially constant over the lifecycle of the printhead. The nozzle pressure is therefore maintained substantially independently of any pressure variations in the supply apparatus caused by wear, movement or fluid flow variations due to the print pattern.

Preferably, fluid is circulated continuously around the supply apparatus, including the reservoir, and this means that all fluid in the system is periodically passed through all components ensuring uniformity of fluid in the supply, and minimising problems associated with stagnant ink locations. By controlling the fluid conditions in each component of the supply apparatus, such continuous cycling minimises the possibility of ink contamination. In a particularly advantageous arrangement, the reservoir is maintained at a partial vacuum, and continuous ink circulation ensures all of the fluid in the supply is subject to a negative pressure on average. Such a negative pressure substantially prevents gas becoming entrained in the fluid, reducing the likelihood of printhead failure due to air bubbles in the ink.

The deposition device and the reservoir may be relatively moveable, in which case the pressure controllers are advantageously located in a fixed spatial relationship to the deposition device. A pressure controller which moves with the printhead in this way prevents any pressure pulses generated by the relative movement from affecting the pressures at the print head inlet and outlet and thus the correct operation of the printhead. This is particularly useful in applications requiring the print head to be scanned relative to a substrate. The inlet and outlet pressure controllers are preferably mounted on the deposition device and can usefully be integrated as a single unit. This provides a single unit which can easily be mounted on a carriage, fed by flexible flow and return conduits (and optionally an umbilical for pressure and control lines). As noted above, since the pressure is controlled at the printhead, pressures in the flow and return conduits need not be accurately maintained. The pressure regulator ensures that any variations in pressure resulting from the movement of the flexible conduit do not affect the print head. In addition, the scanning mass is minimised.

It is known that the temperature of the fluid entering the printhead should be controlled, and should be insulated from fluid exiting the printhead, which has been heated by the printhead. When the inlet and outlet pressure controllers are integrated, it is therefore desirable for the inlet fluid path to be insulated from the outlet fluid path.

In a preferred embodiment, the inlet and outlet pressure controllers comprise a tank having a free surface of fluid defining a static head of fluid at the inlet and outlet. The inlet and outlet pressures can further be controlled by the pressure in the space above the free, surface. Controlling the pressures above the free surfaces allows the pressure controllers to be placed at any height relative to the droplet deposition device. By selecting these pressures to be atmospheric above the inlet tank and negative above the outlet tank, the controllers can be placed at the same height and still maintain the nozzle pressure at a slightly negative value. The heights of said free surfaces in the tanks are desirably determined by an overflowing weir.

The tanks can be mounted directly on the droplet deposition device and a conduit may connect the tank to the inlet and outlet. The pressure drop across this conduit should be negligible compared to the pressure drop across the device. The conduit is preferably rigid, and desirably less than 200 mm and more desirably less than 100 mm in length. It is most desirable for the conduit to be not longer than 50 mm. The conduit bore is advantageously greater than 5 mm, and can be selected to match the inlet and outlet apertures of the droplet deposition device.

The system may comprise a plurality of deposition devices supplied from said reservoir. Moreover, the plurality of deposition devices may be connected in parallel to said pressure regulator which maintains the fluid pressures at the inlets and outlets of said plurality of deposition devices at the desired values. This may be appropriate where multiple print heads are arranged side by side in order to increase the print resolution and/or the print swath width. A number of printheads can desirably be integrated with an inlet and outlet pressure controller in a single unit.

According to a second aspect, the invention provides a method for supplying fluid to a droplet deposition device, the droplet deposition device having an inlet, an outlet and including at least one pressure chamber in communication with an ejection nozzle, the method comprising receiving, at the inlet to said droplet deposition device, a flow of fluid from a remote supply; applying fluid to said inlet at a first predetermined pressure; receiving fluid from the outlet of said droplet deposition device at a second predetermined pressure independent of said first pressure; and returning, from the outlet of said droplet deposition device, a flow of fluid to said remote supply; wherein the difference between said first and second predetermined pressures drives a flow of fluid through said at least one pressure chamber.

A third aspect of the present invention consists in a droplet deposition system comprising a deposition device having a fluid inlet, a fluid outlet and at least one nozzle for droplet ejection; a fluid supply assembly comprising a fluid reservoir and a fluid supply circuit for circulating fluid from said reservoir, through said deposition device via said inlet and said outlet, and back to said reservoir; the system arranged such that the average pressure over the total free surface of fluid in the system is below ambient pressure.

The invention will now be described by way of example with reference to the accompanying drawings, in which:

FIG. 1 shows a prior art ink supply arrangement

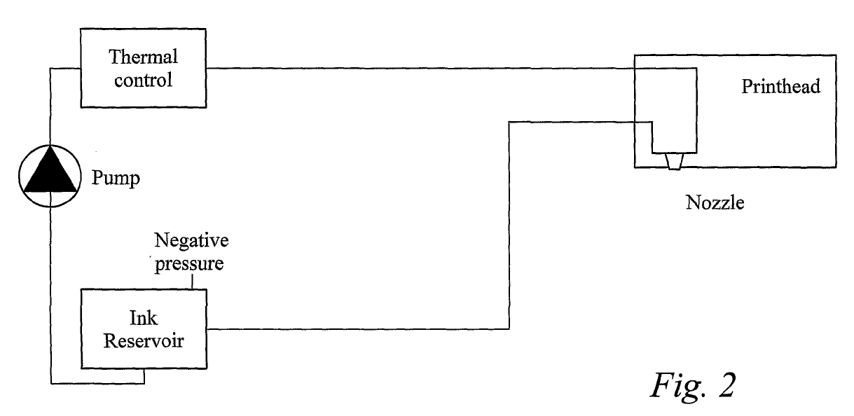

FIG. 2 shows a closed recirculating ink supply

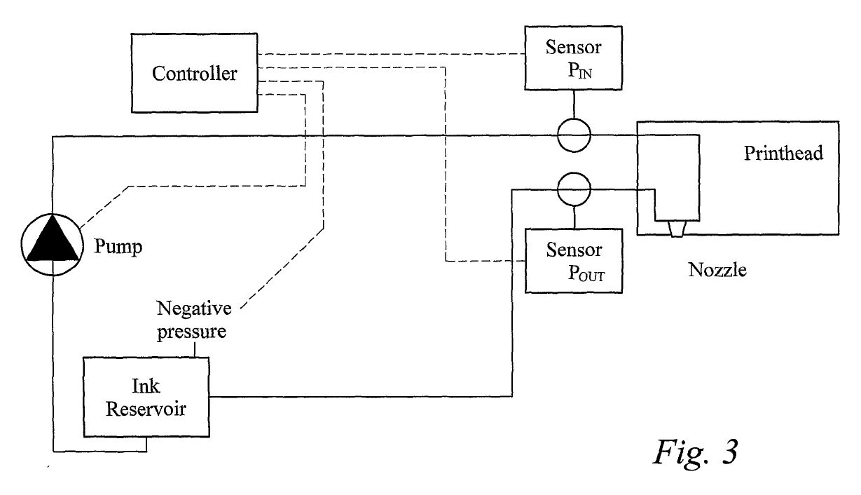

FIG. 3 is an enhancement of FIG. 2 including feedback

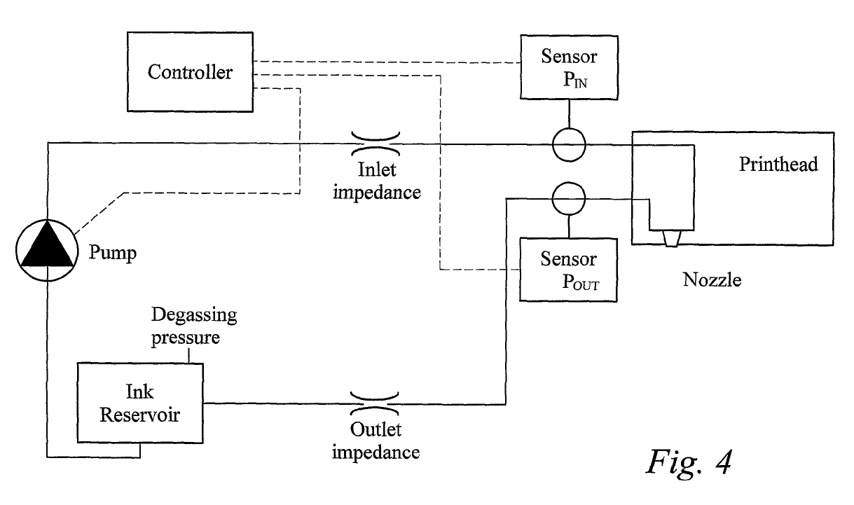

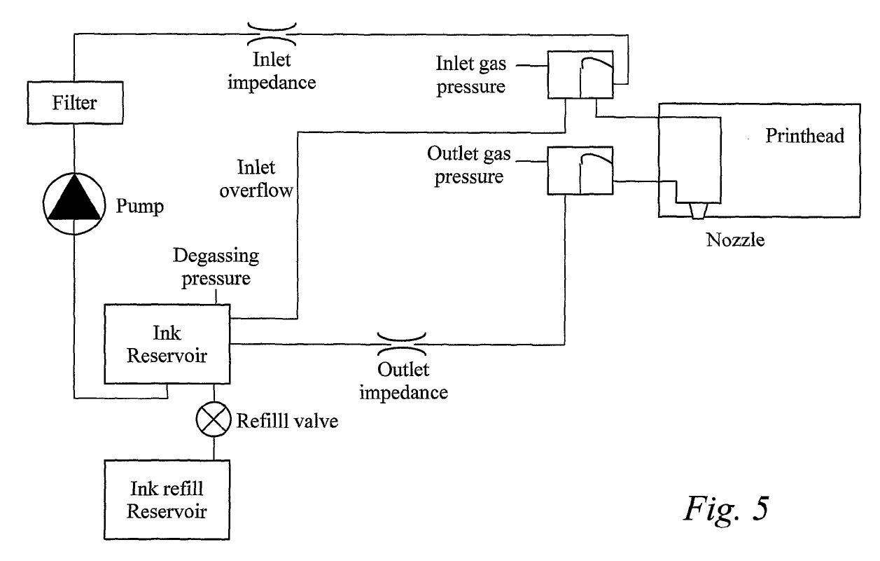

FIGS. 4 and 5 show further embodiments of the ink supply of FIG. 2 including inlet and outlet weirs.

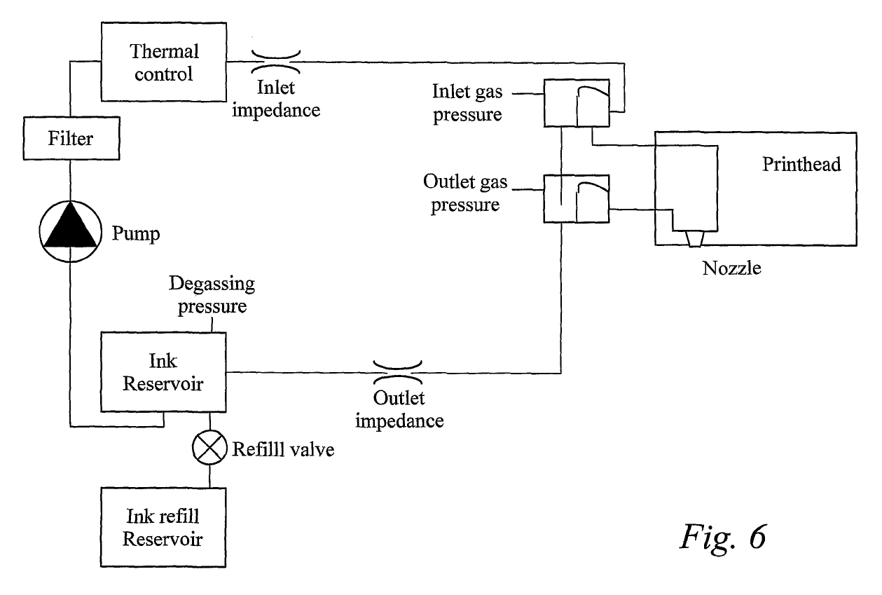

FIG. 6 is a schematic diagram of an embodiment of an inkjet printing system according to the present invention;

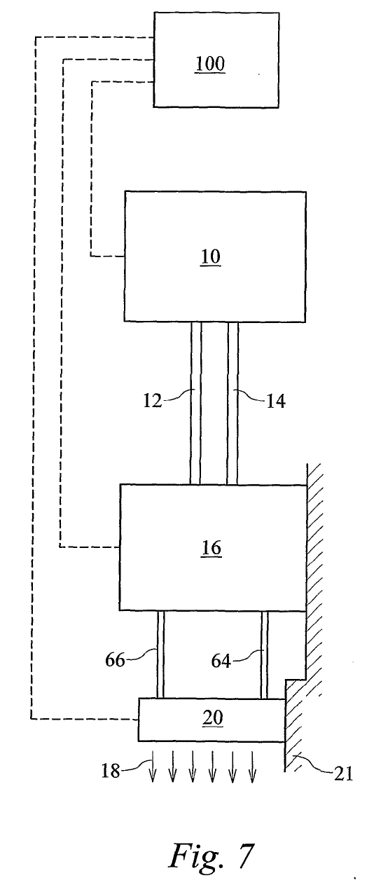

FIG. 7 is a schematic diagram of an embodiment of a print head module of the system;

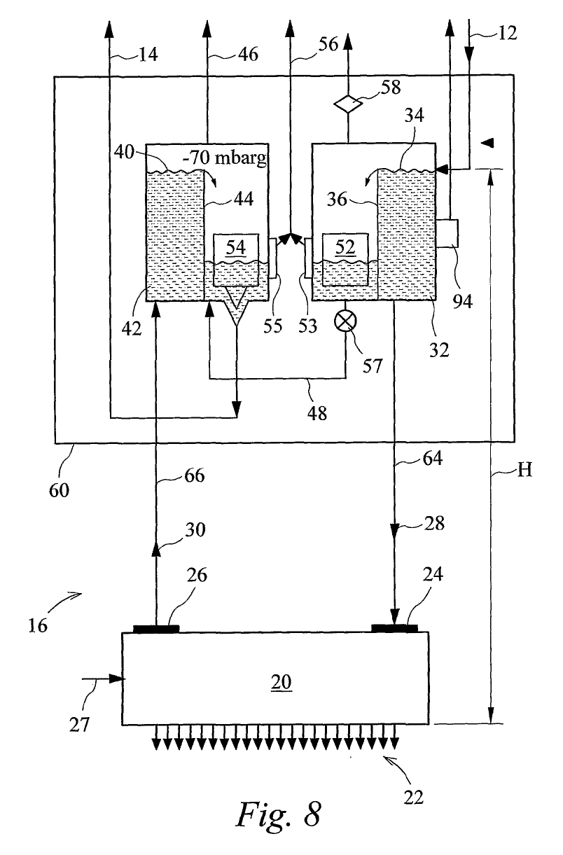

FIG. 8 is a cut-away view of a preferred embodiment of the print head module;

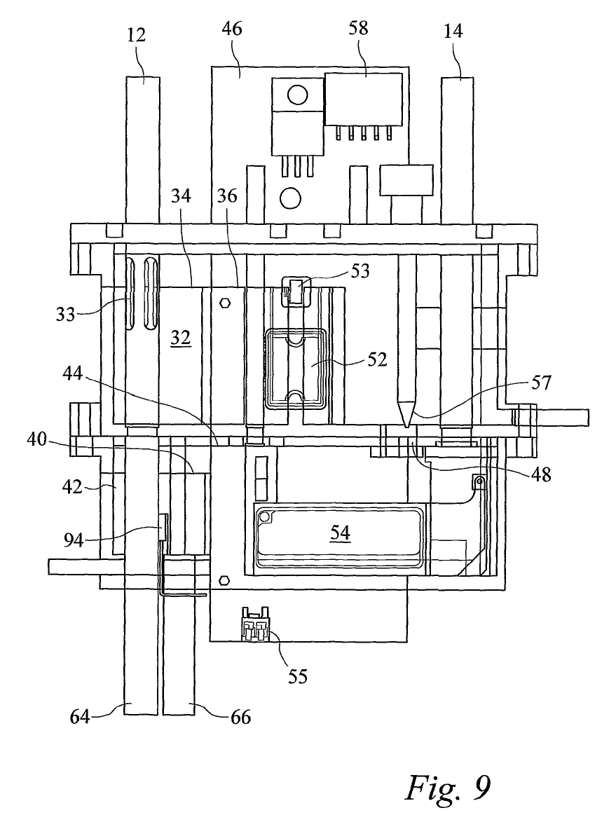

FIG. 9 is a schematic diagram of the first, reservoir module of the system;

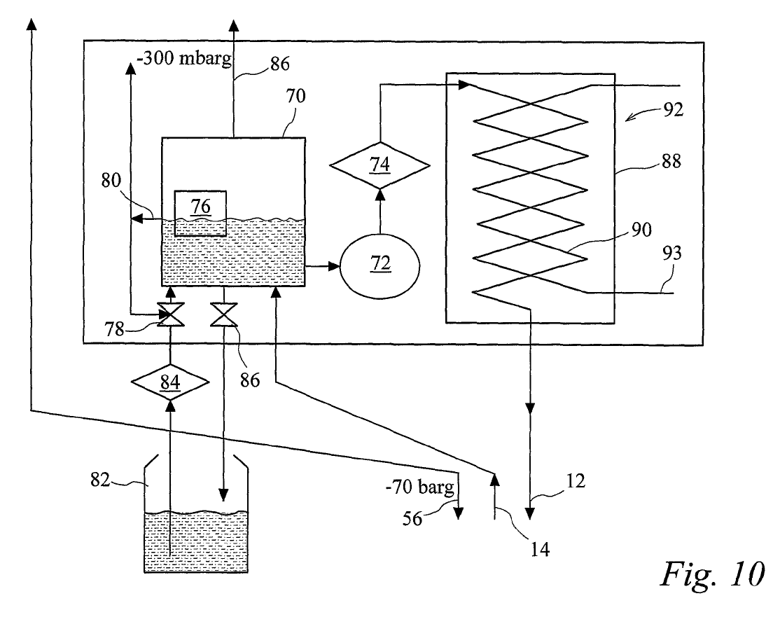

FIG. 10 is a cut-away view of a preferred embodiment of a reservoir module;

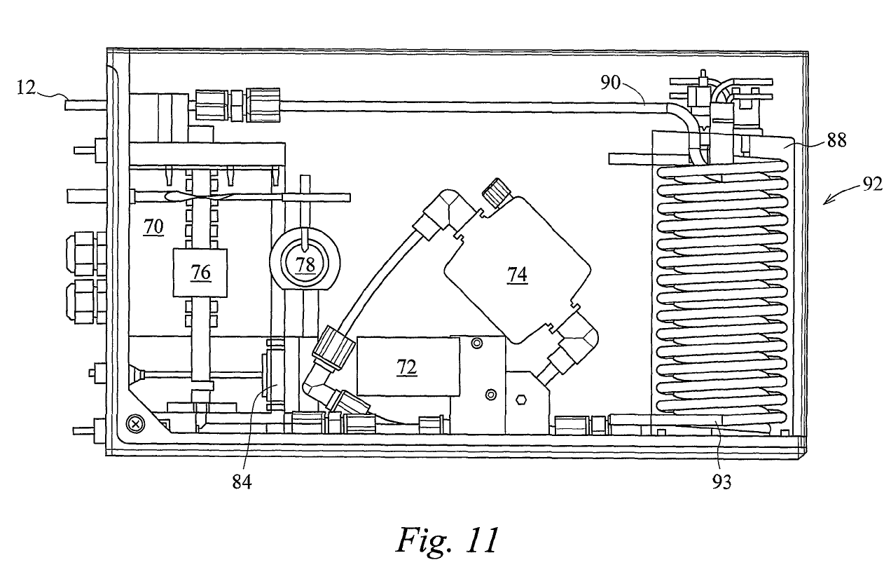

FIG. 11 is a schematic diagram of a third, controller module of the system;

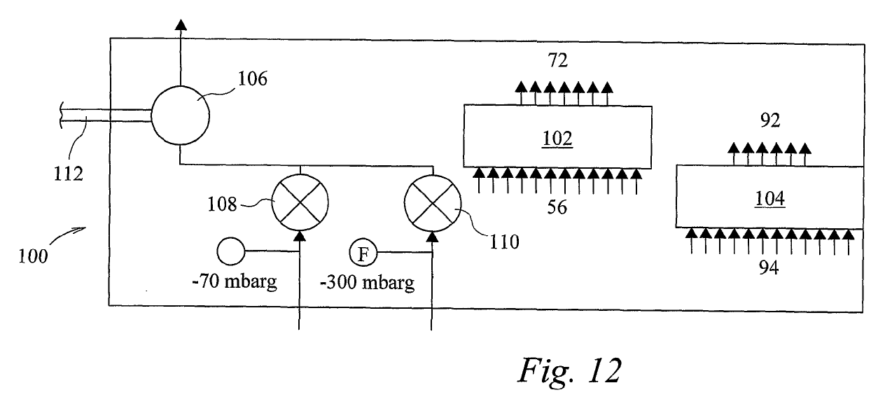

FIG. 12 shows an embodiment of the invention utilising two printheads;

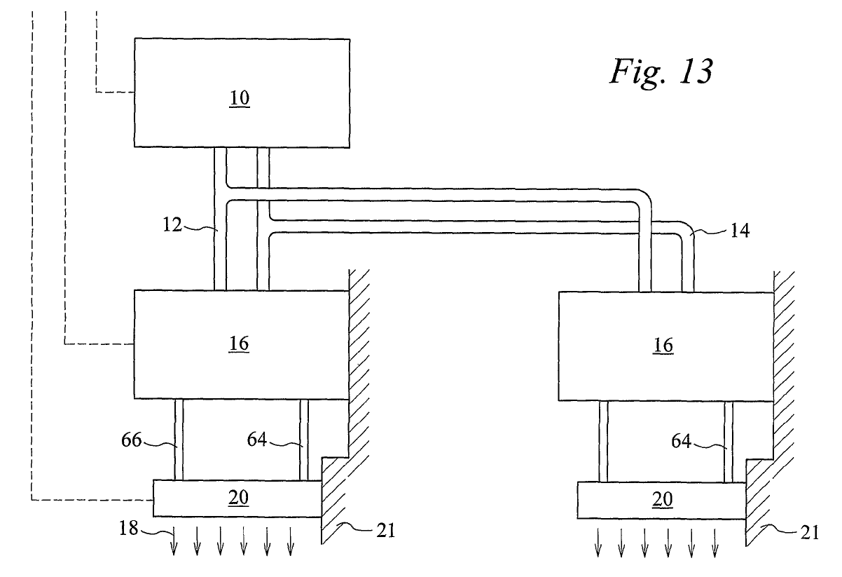

FIG. 13 shows a further embodiment of the invention utilising two printheads;

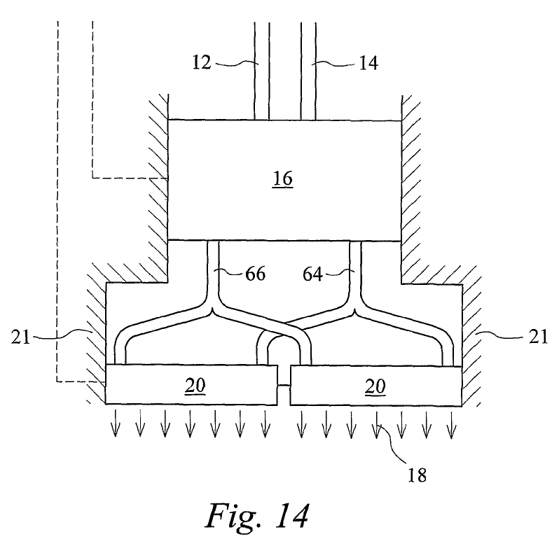

FIG. 14 shows an embodiment of the invention using multiple printheads.]

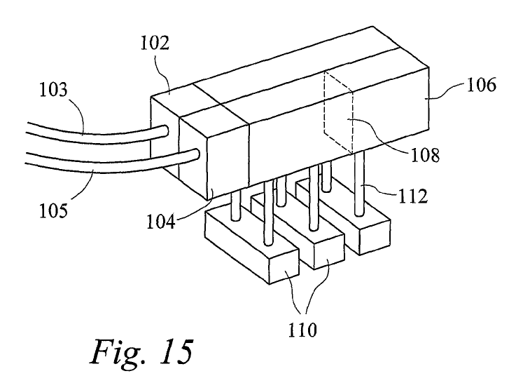

FIG. 15 illustrates a pressure control unit for multiple preintheads.

FIG. 2 shows a closed, thermally managed, recirculating-through-ejection chamber fluid supply with sub-atmospheric pressure at the nozzle. It has the advantage of being fully enclosed from the atmosphere (other than at the nozzle) so that there is no issue with gas absorbtion. The system is also simple and so low cost. It is also compact and is flexible as regards component location, particularly the height thereof. The pump generates a positive pressure upstream and a negative pressure downstream with the pump speed being chosen such that a flow exceeding the maximum printhead(s) ejection flow is maintained. Flow is typically ten times the maximum ejection rate and may be up to 30 times the maximum ejection rate.

The pumping circuit, including flow paths internal to the printhead, between the pump and nozzle is substantially symmetrical in its fluidic impedance but to generate the small sub-atmospheric pressure required at the nozzle, the side of the circuit providing the inlet to the printhead has a slightly higher impedance. It is noted that the symmetrical arrangement is most convenient since it is most useful to have the pump remote from the printhead, but non-symmetrical embodiments can be configured with the conduit impedance being biased accordingly.

The ink reservoir is maintained at a pressure appropriate to its position in the circuit. In the embodiment shown a small vacuum is required where the reservoir is located close to the pump inlet; this is known to be advantageous since the gassing of ink can be reduced. It is advantageous if the ink is contained within a collapsible reservoir such that air does not contact ink in the pumping circuit. It is feasible to have the reservoir anywhere in the circuit with an appropriate change of applied pressure. Observation of the ejection performance (drop formation) can be used to inform the condition of the ink system and corrective adjustment made to the pressure applied to the reservoir, for example. Additionally, should the system components need to be located at particular heights then the reservoir pressure can be used to correct nozzle pressure.

This system requires that care is taken in the design and manufacture of components and fluids such that the fluidic impedance is adequately controlled. Since uniformity of fluid viscosity also affects the fluidic impedance, it may be desirable to manage the temperature of the fluid carefully e.g. by means of a thermal control. It may also be desirable to have the volume of ink in the circuit, and hence thermal mass, small such that operating temperature is achieved in a short period after start-up.

The pump should be smooth such that pressure pulses are unable to disrupt the nozzle meniscus (pressure at nozzle). Gear pumps are an example of a suitable type.

Advantageously, so allowing a greater freedom in the choice of pump type, the reservoir will act as a buffer (due to the bulk and compliance of the fluid within and more significantly the compliance of the container/bag itself). The thermal control unit (heater and/or cooler and/or heat exchanger) exhibits similar properties. Finally, it could be the conduit (or regions thereof) that provide adequate compliance. It may be desirable that compliance/buffering is applied to both the pump flow and return lines.

Advantageously, this system can be configured to have no ink vulnerable to atmospheric gassing (other than at the nozzles themselves, which are less problematic).

In summary, this first embodiment comprises a printhead, a pump, a conduit, a reservoir and a thermal control connected in a circuit. In practice, it can be difficult to maintain required tolerances since manufacturing tolerances and component wear (e.g. pump) and variation in fluid types/batches will lead to changes in system pressure.

Thus FIG. 3 shows an alternative system is proposed wherein a feedback loop is used to control the pressures in the pumping circuit. A pressure sensor(s) is located at or close to the printhead and via a control system is used to manage system pressures. In the embodiment illustrated the flowrate (pump speed) or the pressure applied to the reservoir are shown as being controlled. Equally changes to the system impedance (e.g. conduit diameter via a restrictor) could be applied.

Advantageously, the inclusion of a feedback system can be used to save cost. The thermal control could be removed and components of less precision employed. However, the inclusion of thermal control remains compatible with this embodiment.

The impedances between the sensor P_{IN} (at the inlet) and the nozzle and between the nozzle and P_{OUT} (at the outlet) are known and well controlled (this is easy with the precise manufacturing methods used in printhead fabrication). This allows the pressure at the nozzle to be determined by and closely controlled via the feedback loop.

The pressure difference between P_{IN} and P_{OUT} determines the flowrate through the printhead which should be significantly greater than the max ejection rate. This flowrate is constant in the recirculating system while no fluid is ejected from the nozzles.

Despite being subjected to a small negative pressure, fluid in the reservoir will continue to dissolve atmospheric gases. To prevent gas absorption, sub-atmospheric pressure must be significantly lower that the sub-atmospheric pressure (500-2000 Pa) required at the nozzle. The pressure at the reservoir should be selected so as to overcome the impedance of the return pipe from the printhead outlet, which impedance depends amongst other things on the length of the pipe. The embodiment of FIG. 4 incorporates additional impedance provided by a fluid restrictor where the conduit is short (where the system is closely integrated) or by the conduit itself where it is long or of small diameter (e.g. in applications where printheads are packed closely together or in scanning applications).

Advantageously, the ink reservoir can now be subjected to larger sub-atmospheric pressure that prevents gas absorption and can actively cause the fluid to degas, while the pressures close to the printhead remains as per the previous embodiment. The reservoir should now be of the open type with air (or gas) at sub-atmospheric pressure applied to a free surface such that gas dissolved in the fluid is free to escape. The reservoir is desirably arranged such that fluid entering the reservoir remains close to the surface for a period of time eg. by having a tangential inlet to a cylindrical reservoir, entering fluid ‘swirling’ on the surface. A further advantage of exposing fluid in the supply to a negative pressure is that (non-aqueous) fluid may undergo dehumidification or drying. For such fluids, water vapour is removed through the vacuum pump providing the negative pressure. These processes can be accelerated by careful design of the fluid flow paths inside of the reservoir. As before, thermal control is compatible with this system (but not shown)

FIG. 5 shows a further embodiment of the invention in which buffer and pressure regulation functions are incorporated into a device containing a weir. Fluid from the pump outlet flows into a weir that maintains a fluid level with excess fluid flowing over the weir and returning to the reservoir. A pressure is applied to the gas volume above the inlet weir and/or alternatively a static head height can be configured. The ink volume restrained by the weir feeds the printhead inlet. Ink flowing through the printhead outlet returns to a second weir where upon a gas pressure and/or static head is applied. The weir acting to maintain the presence of a free surface of the ejection fluid. The gassing of fluid is minimised since the ink volume within the weir is very small (compared with that of the reservoir), and is changed regularly due to the rate of recirculation, and the fluid areas exposed to the gas are also small.

Additionally, the larger negative pressure applied to the ink reservoir is used to draw fluid from a refill reservoir, a system level sensor used to control a refill valve. The refill reservoir can be placed above or below the ink reservoir. It is worthy of further note that ‘fresh’ fluid is ideally added to the ink reservoir such that it is suitably conditioned (degassed, pressurised, heated/cooled and filtered) prior to supply to the printhead.

FIG. 6 corresponds to the embodiment of FIG. 5 but includes control valves and an inlet overflow that returns to the outlet weir. In summary, it comprises a printhead, a pump, a conduit with high impedance, a reservoir and pressure regulation.

Referring to FIG. 7, an inkjet printing system according to the present invention comprises a first, reservoir module 10 connected by inlet and outlet conduits 12,14 to a second, pressure regulation module 16 connected by further conduits 64,66 to a print head 20 that deposits ink as indicated by arrows 18. As indicated by dashed lines in FIG. 2, the various components may be controlled from a further controller module 100.

Printhead head 20 is moveable relative to the reservoir module 10, e.g. on a printer carriage indicated at 21, and to this end conduits 12,14 may be flexible tubing. Pressure regulator 16, in contrast, is not allowed to move relative to the print head and may also be attached to printer carriage 21. Per the invention, pressure regulator 16 ensures that pressure fluctuations resulting e.g. from the movement of the flexible tubes 12,14 as the print head is scanned are not transmitted to the print head. The fixed spatial relationship between pressure regulator and print head further ensure that no pressure fluctuations arise in the tubes 64,66 connecting the latter two components. As shown in FIG. 8, module 16 comprises a print head 20 having an ink inlet 24, an array of nozzles 22 for ink ejection and 5 an ink outlet 26. Electrical actuation signals are fed to the print head via cable 27. Ink is circulated through the print head as indicated by arrows 28, 30 so as to remove dirt, air bubbles and heat that might otherwise interfere with the operation of the print head.

As is known, satisfactory operation requires that both the pressure within the print head and the pressure difference between inlet and outlet be controlled. To this end, ink is supplied to the inlet 24 from an inlet tank 32 having a free ink surface 34 exposed to atmospheric pressure via optional filter 58 and maintained by an overflowing weir 36 supplied with conditioned ink from inlet conduit 12. Mechanical adjustment means (not shown) allow the height H of the ink surface 34 above the nozzles 22 to be adjusted, a typical value of H being 250 mm. Where H is required to be large, e.g. where it is necessary to locate the print head 20 some distance below pressure regulator 16, the resulting head of ink may exceed the operating pressure range for the print head inlet 24. In such circumstances, an air pressure lower than ambient may be applied to the free ink surface via filter 58 so as to correct the pressure at print head inlet 24.

The pressure at outlet 26 is also determined by a free surface 40 in outlet tank 42, albeit exposed to sub-atmospheric pressure, typically −70 mbar gauge, via vacuum line 46. Surface 40 is maintained by overflowing weir 44 supplied from the print head outlet 26. Overflow 50 from outlet tank 42 feeds back to the ink reservoir via outlet conduit 14

Outlet tank 42 has a float valve 54 downstream of the weir 44 to maintain a working level of fluid above the inlet to conduit 14 and prevent air entering the system and vacuum being lost should that level drop, as may be the case when the print head is operating at maximum ejection rate. The float valve 54 is maintained in about mid range by manually adjusting the −450 mbar nominal vacuum in the main reservoir 70. The float valve 54 then controls the flow out to match the overall flow in to tank 42 (this being the sum of return flow 30 and inlet tank overflow 48) by falling or rising, obstructing the exit more or less, respectively.

Overflow 48 from inlet tank 32 into outlet tank 42 is controlled by a valve, e.g. a needle valve 57, which requires only initial manual adjustment. Thereafter, flow through the valve is maintained substantially constant by control of the head of ink above the valve which in turn is determined by the amount of ink supplied to the tank from pump 72 via inlet 12. Specifically, float 52 in combination with sensor 53 provides a signal 56 indicative of ink level, which signal is in turn fed to a controller 100,102 which controls the speed of the ink supply pump 72 as discussed in more detail below. This avoids entrainment of air in drain flow 48 at one extreme and flooding of weir 36 (and thus increase in the associated fluid head) at the other.

A similar sensor may be installed on the outlet ink tank 42 as shown at 55, the sensors on both tanks serving 5 to indicate when a float valve or float is outside its range and warn the operator of a failure situation.

Additional valves—possibly solenoid operated—may be provided to cope with extreme level changes, for start-up and shut-down.

Tanks 32 and 42 together define a pressure regulator 60 which together with print head 20 makes up print head module 16. As noted above, it is desirable to thermally insulate (cool) inlet ink from (warm) outlet ink. In the arrangement described, bypass flow 48 passes only from inlet to outlet, and is therefore not a problem, however it is noted that tanks 32 and 42—especially when integrated as a single unit—should be provided with some degree of thermal insulation.

To minimise variations in the pressure differences between the regulator and the respective print head inlet and outlets, regulator 60 is preferably arranged a fixed vertical distance above the print head 20, advantageously occupying a similar footprint to the head (although other orientations are possible e.g. by means of differently bent connections). Similarly, to minimise the effect of flow variations on the inlet and outlet pressures, the connections 64 and 66 between regulator and print head are preferably of large diameter, typically 6 mm bore in the arrangement detailed above. This results in a typical ink speed of around 100 mm per second and corresponding dynamic pressures and friction pressure drops of around 0.5 and 1 mbar respectively. This can vary by +/−5% as the ink flow varies by +/−5% as described above. However, such variation of +/−75 microbars is negligible in comparison to the 60 mbar pressure drop between the inlet and outlet manifolds of the print head. Indeed, a variation of up to 4 mbar, i.e. +/−7% of the pressure drop between print head inlet and outlet, is believed to be possible without having any deleterious effect on the operation of the print head. In the limit, the regulator/print head connections can be dispensed with altogether by integrating the pressure regulator into the manifold of the print head itself.

The pressure regulator 60 in the print head module, 16 allows the inlet and outlet conduits 12,14 to be chosen without regard to the pressure requirements of the print head 20. Small bore flexible pipes permit easy movement of the print head and can be incorporated into a single common umbilical together with vacuum line 46 and print head input signal cable 27 and further leads for float position data, valve control signals and the like. Electronic interface boards and connectors may also conveniently be incorporated into the print head module.

Moreover, small bore pipes ensure that the velocity of ink therein is high increase the thermal control response time between sensors at the printhead inlet and the heater in the ink supply module. Whilst acceptable control can be achieved with an average velocity in the conduit of 1 metre per minute, velocities greater or equal to approximately 16 metres per minute result in narrow conduits of greater flexibility better suited to scanning applications.

FIG. 9 is a cut-away view of a preferred embodiment of a print head module 16 incorporating the above elements. The nominal flow rate through the print head is 200 ml per minute (+/−5% depending on the amount of ink ejected through the nozzles), typical values for the pressure difference between print head inlet and outlet are in the range 50 to 80 mbar, nominally 70 mbar, while the nominal sub-atmospheric static pressure at the ‘nozzle is minus 10 mbar gauge (+/−1 mbar), although pressures as low as −30 mbar have been found to work successfully.

Inlet tank 32 is supplied with ink from inlet conduit 12 which extends below the ink surface level 34 as determined by the weir 36. At the same time, the conduit is provided with one or more apertures 33 above ink surface level which allow any pressure fluctuations in the conduit (and caused e.g. by the pump 72 discussed below) to dissipate and therefore not affect the supply to the print head. Apertures 33 can additionally be made short in the direction of ink flow—the longitudinal axis of the conduit 12—so as to minimise the amount of time (to around 20 ms in the configuration detailed above) that ink is exposed to the air in the space above the ink surface 34. Moreover, any outer layers of ink flow into which air might diffuse are shed through the apertures 33 into the weir pool downstream of weir 34.

The above measures ensure that none of the benefits of the ink degassing (or at least prevention of gas absorption) that takes place in the main reservoir 70 are lost. As discussed in detail below, ink spends about 60% of its time in the reservoir at a typical pressure of minus 400 mbar and around 35% of its time sealed under pressure in the heater or pipes. The only exposure to air at atmospheric pressure takes place in the inlet tank where a typical quantity of around 10 ml is exposed over an area of around 10 square centimetres for about ten seconds before being fed back to the main reservoir via line 48, outlet tank 42 and outlet conduit 14.

In the example of FIG. 8, the regulator is positioned such that its upper weir is located 250 mm directly above the print head nozzles and the total pipe losses between regulator and print head are approximately 3 mbar. The weirs are also made narrow in the direction in which the print head module is to be scanned so as to minimise acceleration effects, a weir width of about 25 mm lowering the level in the centre of the reservoir by less than 5 mm (equivalent to approximately 0.5 mbar) under an acceleration of 0.4 g.

It will be understood that for the weirs of the pressure regulator to operate correctly, the amount of ink pumped through the pressure regulator must be in excess of the amount of ink flowing through the print head and preferably by at least 20%. Higher excess rates, possibly even 100%, reduce the time taken for the ink in the print head to reach the correct operating temperature following start up. Ink may take 20 seconds to travel from the middle of unit 92 to print head 20 at the flow rates given above, corresponding to a flow velocity of 16 metres per minute. As a result, the time period for the temperature control 5 system may be several minutes and the warm-up time (from a typical ambient start-up temperature of 24° C.) around half an hour.

This warm-up time can be reduced by putting a quantity of heat—about 60 kJ in the system of FIGS. 4 and 6—quickly into the system at start-up so as to warm up all the thermal mass of the system without regard to local temperature overshoots. The circulating ink soon disperses the heat and, once the print head is close to its operating temperature, the control system described above can be switched on. Specifically, the cartridge heaters in unit 92 are initially switched on for a preset time and thereafter controlled with temperature feedback from the unit 92 to a target temperature that exceeds the operating temperature of the print head so as to allow for heat losses occurring e.g. in the conduit 12 connecting the two modules. In the arrangement described above, this target temperature typically exceeds the nominal print head operating temperature by 50% of the temperature difference between the print head operating temperature and ambient, say 48° C. heater temperature for a nominal operating temperature of 40° C. and an ambient temperature of 24° C. Once the temperature of the system has stabilized and the print head is close to its operating temperature, control is switched to temperature feedback from the print head sensor 94 which rapidly brings the print head the few remaining degrees to its final operating temperature, allowing printing to start. As discussed below, this regime may be implemented by a separate controller module. Moreover, the controller may be self-teaching, recording the various temperature differences between ambient, heater and print head in order that it might adopt the appropriate heater duty cycle on future occasions. The operating temperature can of course be adjusted depending on the ink type, e.g. to achieve the necessary ink viscosity. Where the ink is a suspension, agitators can be added to the main reservoir and/or sub-reservoirs as is known per se.

Note that it is usual to operate pump 72 at reduced speed until the ink viscosity—which is dependent on ink temperature—is near its operating value. It will be appreciated that such a reduction reduces the rate at which heat is circulated throughout the system and that, by accelerating the increase in ink temperature, the above control regime will bring forward the point at which heat can be circulated at full speed throughout the system, further reducing the system warm-up time. Alternatively or in addition, a time switch may be used to start the system early so that it has warmed up by the time printing is to take place. Arranging a heater close to the sensor on the print head or pressure regulator will also influence the warm-up performance of the system.

FIGS. 10 and 11 illustrate the components of the reservoir module 10, which is preferably packaged in a small block, suitable for stacking or rack mounting. Tank 70 stores a working quantity of ink (typically 200 ml) held under a vacuum via vacuum connection 86. In addition to drawing ink out of the print head module 16, this vacuum also prevents gas absorption and may actively degass the ink (as a result of the ink spending around 80% of its time in the tank 70 at a typical temperature and pressure of 34° C. and minus 450 mbar gauge respectively). It also allows fresh ink (from bottle 82 and filter 54) to be drawn up into the tank via solenoid valve 78 which opens whenever the level of float 76, as sensed by sensor 80, falls below a certain level. Tank 70 also has a manual drain valve 86 to allow the ink in the entire system to be changed.

Ink is pumped from the tank 70 into inlet conduit 12 by means of a pump, e.g. a diaphragm pump 72, having first been conditioned by a filter, e.g. a 5 micron capsule filter 74, and an ink heating/cooling unit 92. The latter may comprise a stainless steel coil 90 embedded in an aluminium block 88 and surrounding two cartridge heaters (not shown). A second outer coil 93, also embedded in the aluminium, may be used for cooling water if desired.

Unit 92 may be controlled in dependence on a signal from sensor 94 on inlet tank 32 or supply pipe 64 of the print head module. However, for the typical arrangement of a print head module connected to a reservoir module by an unsheathed inlet conduit 12 of 4 m length and 4 mm bore,

Controllers for the various valves, pumps, heaters and indeed the print head itself may advantageously be located in a further module, separate from the reservoir module 10, as depicted schematically in FIG. 12. Controller module 100 has a section 102 that processes the float signals 56 from the print head module 16 to set the appropriate speed of the pump 72 and a section 104 which uses the temperature signal 94 to control the heater 92 by supplying suitable power. The controller may also control valves in the print head module to deal with high or low level of the floats and extra switch outputs for indication and alarm purposes. It may have a connection to factory air supply 112 to drive a vacuum ejector 106, or an in-built vacuum pump, and two manually or electronically-set vacuum regulators 108,110 with local pressure indication for supplying high vacuum (typically minus 450 mbar gauge) to the reservoir tank 10 and low vacuum (typically minus 70 mbar gauge) to the print head module 16. As a result of pressure being controlled individually in each print head module, single reservoir and controller modules can be used to service several print heads Moreover, one controller may control several reservoir modules, supplying them all with the same two levels of vacuum.

As shown in FIG. 13, the system may comprise a plurality of print heads 20 supplied from a single reservoir module 10, thereby reducing the number of reservoir modules required. Furthermore, a single pressure regulator 16 may regulate the fluid pressures for several print heads 20, as shown in FIG. 14. This may be appropriate where multiple print heads are arranged side by side in order to increase the print resolution and/or 5 the print swath width as is known per se. A further extension of this concept is shown in FIG. 15, in which an inlet pressure controller 102 and an outlet pressure controller 104 are each connected to a long pressure bus 106. Pressure controllers are fed by inlet and outlet pipes 103 and 105 respectively, and optional control and pressure lines (not shown). The pressure bus should have a large cross section (shown dashed at 108) to ensure substantially no pressure variation along its length. A number of printheads 110 are then connected along the length of the bus via short conduits 112, although the printheads could equally be connected directly to the bus. This provides a compact print module having direct pressure control at the head for a number of replaceable heads.

It should be understood that the present invention has been described by way of example only and that a wide variety of modifications can be made without departing from the scope of the invention. In particular, the invention is not restricted to the particular pressure regulator described above but can utilize any suitable means for maintaining fluid pressure within predetermined operating ranges.

We claim:

1. Fluid supply apparatus for supplying fluid to a droplet deposition device, the droplet deposition device having an inlet, an outlet and including at least one pressure chamber in communication with an ejection nozzle, said apparatus comprising:
a fluid reservoir for supplying fluid to and receiving fluid from the droplet deposition apparatus;
an inlet pressure controller adapted to receive fluid from said reservoir and maintain the pressure of fluid at said inlet at a first predetermined value;
an outlet pressure controller adapted to return fluid to said reservoir and maintain the pressure of fluid at said outlet at a second predetermined value;
the difference between said first and second values driving a flow of fluid through said at least one pressure chamber.

2. Apparatus according to claim 1, wherein during droplet deposition, fluid circulates continuously from said outlet pressure controller, through said reservoir and to said inlet pressure controller

3. Apparatus according to claim 1, wherein said inlet pressure controller maintains the pressure of fluid at said inlet independently of any variation in pressure of fluid supplied to said inlet.

4. Apparatus according to claim 1, wherein said outlet pressure controller maintains the pressure of fluid at said outlet independently of any variation in pressure of fluid returned from said outlet.

5. Apparatus according to claim 1, wherein said inlet pressure controller is spatially fixed relative to said droplet deposition device.

6. Apparatus according to claim 1, wherein said outlet pressure controller is spatially fixed relative to said droplet deposition device.

7. Apparatus according to claim 1, wherein said inlet and outlet pressure controllers are located at substantially the same height relative to the droplet deposition apparatus.

8. Apparatus according to claim 1, wherein said inlet and outlet pressure controllers are integrated in a single unit.

9. Apparatus according to claim 1 wherein said pressure controllers are mounted to said droplet deposition device.

10. Apparatus according to claim 1, wherein said pressure controllers and said droplet deposition device are integrated into a single unit.

11. Apparatus according to claim 1, wherein said inlet pressure controller comprises a first tank connected to said inlet, a free surface of fluid in said first tank defining a static head of fluid at said inlet.

12. Apparatus according to claim 11, wherein the height of said free surface in said first tank is determined by an overflowing weir.

13. Apparatus according to claim 11, wherein said free surface in said first tank is subject to atmospheric pressure.

14. Apparatus according to claim 1, wherein said outlet pressure controller comprises a second tank connected to said outlet, a free surface of fluid in said second tank defining a static head of fluid at said outlet.

15. Apparatus according to claim 14, wherein the height of said free surface in said second tank is determined by an overflowing weir.

16. Apparatus according to claim 14, wherein sail free surface is subject to a negative pressure.

17. Apparatus according to claim 12, wherein said pressure controllers further comprise a respective trough into which overflowing fluid passes.

18. Apparatus according to claim 17, wherein the rate of fluid flow into said first tank is controlled in dependence upon the level of fluid in said first tank overflow trough.

19. Apparatus according to claim 17, including a bypass passage for fluid flow from said first tank overflow trough to said second tank overflow trough.

20. Apparatus according to claim 17, wherein the level of fluid in said second tank overflow trough controls the rate of flow from said second tank overflow trough to said reservoir

21. Apparatus according to claim 11, wherein said pressure controller includes a conduit connecting said tank to said inlet

22. Apparatus according to claim 21, wherein said conduit is substantially rigid.

23. Apparatus according to claim 21, wherein said conduit is less that 100 mm in length

24. Apparatus according to claim 21, wherein the pressure drop across said conduit is less than 5% of the pressure drop across said droplet deposition device.

25. Apparatus according to claim 21 wherein the pressure drop across said conduit is less than 5 mbar.

26. Apparatus according to claim 21, wherein said conduit has a bore of greater than 5 mm.

27. Apparatus according to claim 1, including a vacuum source for maintaining said remote reservoir at a pressure more negative than either said first or second predetermined pressures.

28. Apparatus according to claim 1, including a pump for pumping fluid between said reservoir and said droplet deposition device, the fluid pressure at said inlet being determined by said pump and a fluidic impedance between said pump and the inlets and wherein said inlet pressure controller monitors the fluid pressure at said inlet and controls said pump to maintain said first predetermined value.

29. Apparatus according to claim 27, wherein the fluid pressure at said outlet is determined by the negative pressure at said remote reservoir and the fluidic impedance between said remote reservoir and the outlet, and wherein said outlet pressure controller monitors the fluid pressure at said outlet and controls said vacuum source to maintain said first predetermined value.

30. Apparatus according to claim 28, wherein said fluidic impedance between components is the impedance of the fluid conduit connecting those components.

31. Apparatus according to claim 28, wherein said fluid impedance between components includes the impedance of one or more flow restrictors between those components.

32. Apparatus according to claim 1 wherein the droplet deposition device is moveable relative to the fluid reservoir.

33. Apparatus according to claim 1 wherein more than one droplet deposition device is associated with each inlet and outlet pressure controller.

34. Apparatus according to claim 33, wherein said more than one devices are connected in parallel, the pressure at the inlet and outlet of each device being maintained by said inlet and outlet pressure controllers respectively.

35. Apparatus according to claim 34, wherein said more than one devices and said inlet and outlet pressure controllers are integrated into a single unit.

36. A method for supplying fluid to a droplet deposition device, the droplet deposition device having an inlet, an outlet and including at least one pressure chamber in communication with an ejection nozzle, the method comprising:
receiving, at the inlet to said droplet deposition device, a flow of fluid from a remote supply;
applying fluid to said inlet at a first predetermined pressure;
receiving fluid from the outlet of said droplet deposition device at a second predetermined pressure independent of said first pressure; and
returning, from the outlet of said droplet deposition device, a flow of fluid to said remote supply;
wherein the difference between said first and second predetermined pressures drives a flow of fluid through said at least one pressure chamber.

37. A method according to claim 36, wherein said flow of fluid from said remote supply is received at said inlet at a pressure different from said first predetermined pressure.

38. A method according to claim 36, wherein said flow of fluid to said remote supply is returned from said outlet at a pressure different from said second predetermined pressure.

39. A method according to claim 36, further comprising circulating ink continuously through said remote supply during droplet deposition.

40. A method according to claim 36, further comprising maintaining said remote supply at a pressure substantially more negative than either said first pressure or said second pressure.

41. A method according to claim 36, wherein applying fluid at said inlet comprises maintaining a static head of fluid at said inlet.

42. A method according to claim 36, wherein receiving fluid from said outlet comprises maintaining a static head of fluid at said outlet.

43. A method according to claim 41, wherein said first or second predetermined pressures are determined by said static head and a pressure applied to a free surface of fluid defining said static head.

44. A method according to claim 36, wherein said first predetermined pressure is established by a pump pumping fluid from said remote supply, and a fluidic impedance between said pump and said inlet.

45. A method according to claim 44, further comprising monitoring the pressure of fluid at said inlet and adjusting said pump to maintain said first predetermined pressure.

46. A method according to claim 36, wherein said second predetermined pressure is established by a pump pumping fluid from said remote supply, and a fluidic impedance between said pump and said outlet.

47. A method according to claim 46, further comprising monitoring the pressure of fluid at said outlet and adjusting said pump to maintain said second predetermined pressure.

48. A method according to claim 36, wherein the remote supply is maintained at a negative pressure, and wherein said second predetermined pressure is established by said negative pressure at said remote supply, and a fluidic impedance between said remote supply and said outlet.

49. A method according to claim 48, further comprising monitoring the pressure of fluid at said outlet and adjusting said negative pressure to maintain said first predetermined pressure.

50. A droplet deposition system comprising
a deposition device having a fluid inlet, a fluid outlet and at least one nozzle for droplet ejection;
a fluid supply assembly comprising a fluid reservoir and a fluid supply circuit for circulating fluid from said reservoir, through said deposition device via said inlet and said outlet, and back to said reservoir;
the system arranged such that the average pressure over the total free surface of fluid in the system is below ambient pressure.
